(19) United States
(12) Patent Application Publication
(10) Pub. No.: US 2025/0319746 A1
(43) Pub. Date: Oct. 16, 2025

(54) TWO-PART AIR INTAKE MODULE WITH SLIDE-ON AIR GUIDE ELEMENT AND MOTOR VEHICLE WITH SUCH AN AIR INTAKE MODULE

(71) Applicant: AUDI AG, Ingolstadt (DE)

(72) Inventors: Sebastian ALBL, Weinböhla (DE); Christoph BEHLE, Pörnbach (DE); Stefan WELZ, lngolstadt (DE)

(73) Assignee: AUDI AG, Ingolstadt (DE)

(21) Appl. No.: 19/083,542

(22) Filed: Mar. 19, 2025

(30) Foreign Application Priority Data
Apr. 15, 2024 (DE) 102024110417.1

(51) Int. Cl. B60H 1/28; B60R 16/08; B62D 21/11; B62D 25/08

(52) U.S. Cl. CPC B60H 1/28; B60R 16/08; B62D 21/11; B62D 25/081; B62D 25/082

(57) ABSTRACT

An air intake module for an air conditioning unit of a motor vehicle, having a base element which is configured to be connected to an end wall separating the interior from an engine compartment and/or a cross member of a windshield; an air guide element having an air intake opening, which is configured to be fastened to the base element. The base element has a base edge portion facing the air guide element, and the air guide element has a guide element edge portion facing the base element. The base edge portion and the guide edge portion are adapted such that the air guide element is detachably connectable or connected to the base element by a positive and/or non-positive connection.

### FIELD

The invention relates to an air intake module for an air conditioning unit of a motor vehicle and a motor vehicle with such an air intake module.

### BACKGROUND

From the prior art, an air intake device is known which is integrated in the end wall of the body, as described in DE 10 2007 035 489 A1, wherein the end wall is curved forward to form an air inlet opening. Further, another air intake device is known from DE 10 2011 088 671 A1, in which a downward air inlet opening serves as a drain for condensed water.

To date, known motor vehicles have had a sufficiently large prestige dimension to be able to provide a fresh air path suitable in terms of airflow parameters. The fresh air path is defined in particular by means of the bulkhead components (water tank base, water tank front wall, water tank cover), the end wall between the interior and engine compartment and spring strut mounts. As such, the fresh air is to flow in the width direction of the motor vehicle through the water tank outwardly (to the side) to the fresh air intake module of the air conditioner or air conditioning unit to enable maximum water separation.

The air conditioning unit is arranged on the passenger side, in particular depending on steering, wherein the fresh air path is implemented to the passenger side also specifically to steering, and an air intake module is to be provided there.

Because of the so-called cab-forward design for increased interior volume and requirements regarding a flat front hood, an air path with sufficiently good flow parameters and water separation is no longer possible, in particular in the previous longitudinal and vertical extension. Further, an available installation space, in particular between an end wall separating the vehicle interior and the engine compartment or a windshield cross member and a spring strut tower of the body, is reduced so that the installation or maintenance of components, such as the air intake module, becomes more difficult.

### SUMMARY

An object of the invention is to provide an air intake module for a motor vehicle by which the above disadvantages can be overcome, while allowing easy installation in the motor vehicle where little space is available.

Proposed is therefore an air intake module for an air conditioning unit of a motor vehicle, having a base element which is configured to be connected, more preferably screwed, to a body component of the motor vehicle, more preferably an end wall separating the interior from an engine compartment and/or a cross member of a windshield; an air guide element having an air intake opening, which is configured to be fastened to the base element, wherein the base element has a base edge portion facing the air guide element, and the air guide element has a guide element edge portion facing the base element, wherein the base edge portion and the guide edge portion are adapted such that the air guide element is detachably connectable or connected to the base element, more preferably by means of a positive and/or non-positive connection.

This provides a two-part air intake module which can be easily mounted between the end wall and a spring strut tower, even in confined spaces. As such, the air guide element can also be easily removed for maintenance or cleaning purposes, in particular without the need for tools.

In the air intake module, the air guide element and the base element may be movable relative to one another and guided relative to one another, more preferably they may be translationally displaceable. Stated another way, the air guide element and the base element may be movable relative to one another along an imaginary separating plane.

Also proposed is a motor vehicle with an internal combustion engine and/or electric drive, the motor vehicle having: a body with an end wall separating a vehicle interior from an engine compartment, a windshield cross member arranged below a windshield and at least one spring strut tower arranged in front of the end wall; an air intake module with a base element which is connected to the end wall and/or the windshield cross member, and with an air guide element having an air intake opening, which is fastenable or fastened to the base element, wherein the base element has a base edge portion facing the air guide element, and the air guide element has a guide element edge portion facing the base element, wherein the base edge portion and the guide edge portion are adapted such that the air guide element is detachably connectable or connected to the base element, more preferably by means of a positive and/or non-positive connection.

This may provide the two-part air intake module which can be easily mounted between the end wall and a spring strut tower in confined spaces. More preferably, the base element may be fastened, more preferably screwed, to the end wall without the air guide element attached thereto. Here, the space available because of the air guide element not yet being installed may be used to fasten the base element using a tool. Subsequently, the air guide element may then be arranged on or connected to the base element. As such, the air guide element can also be easily removed for maintenance or cleaning purposes, in particular without the need for tools. In this context, a tool-free latching mechanism between the air guide element and the base element may also be contemplated.

In the motor vehicle, the base element may be arranged below the windshield cross member and adapted such that the air guide element is arranged in front of the windshield cross member, more preferably mountable or mounted on the base element without an undercut to the windshield cross member. In other words, the base element is designed such that it is fastened to the end wall below the windshield cross member, but its base edge portion is designed or arranged such that the air guide element may be fastened thereto without being hindered by the windshield cross member. Stated another way, an imaginary separating plane is formed between the base element and the air guide element, which does not intersect the windshield cross member.

In the motor vehicle, the air intake module may be arranged between the end wall and the suspension strut tower with respect to a longitudinal direction of the motor vehicle.

In the motor vehicle, the air guide element may be movable relative to the base element connected to the end wall and/or the windshield cross member, more preferably displaceable in a translational manner along a height direction. Stated another way, the air guide element may be moved up or down along the imaginary separating plane mentioned above, which is formed between the base element and the air guide element. In this context, it should be noted that the imaginary separating plane does not necessarily have to be aligned vertically but may also be inclined towards a vertical height direction.

An optional, tool-free latching mechanism between the air guide element and the base element may more preferably be brought into a latched state, when the air guide element is completely slid onto the base element. Such a latching mechanism may also be designed to be detachable without tools to be able to remove the air guide element from the base element along the direction of displacement.

The motor vehicle may have a water tank with a bottom element and with a cover element, wherein the air intake module, more preferably the air guide element and its air intake opening, are arranged below the cover element.

In the motor vehicle, a water collection basin provided in the bottom element of the water tank may be located lower than the air intake opening of the air intake module.

Further, an outer side of the air intake module, more preferably the air guide element, may face the interior of the water tank.

### BRIEF DESCRIPTION OF THE FIGURES

Further advantages and details of the invention will become apparent from the following description of embodiments with reference to the figures. In the drawings:

FIG. 1 shows a simplified and schematic perspective view of components of an air intake module;

FIG. 2 shows a simplified and schematic perspective view of a front part of a motor vehicle with an air intake module;

FIG. 3 shows a simplified and schematic side plan view of the air intake module in a semi-assembled state;

FIG. 4 shows a simplified and schematic plan view of a rear side of an air guide element of the air intake module approximately corresponding to the arrow IV of FIG. 1;

FIG. 5 shows a simplified and schematic sectional view approximately according to the section line V-V of FIG. 2.

### DETAILED DESCRIPTION

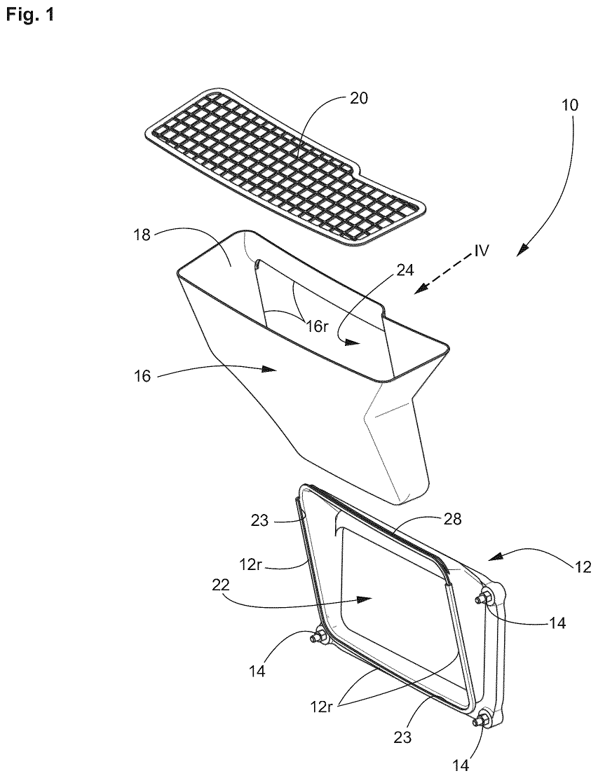

FIG. 1 shows a simplified and schematic perspective view of an air intake module 10 in a kind of exploded view.

The air intake module has a base element 12 which is configured to be connected to a body component of a motor vehicle. One possibility for connecting the base element to the body component may be a screw connection, which is illustrated in FIG. 1 by the screw-nut arrangements 14. However, other types of connection may also be contemplated, such as a clamp connection or a material bonding connection or the like.

The air intake module 10 further has an air guide element 16 which is configured to be fastened to the base element 12. The air guide element 16 has an air intake opening 18. The air intake opening may be covered by a grid element 20 to prevent penetration of larger particles, such as leaves or the like.

The base element 12 has a base edge portion 12r facing the air guide element 16. The air guide element 16 has a guide element edge portion 16r facing the base element 12. As such, the base edge portion 12r and the guide edge portion 16r are adapted such that the air guide element 16 is detachably connectable or connected to the base element 12. More preferably, the air guide element 16 may be attached to the base element 12 by means of a positive and/or non-positive connection.

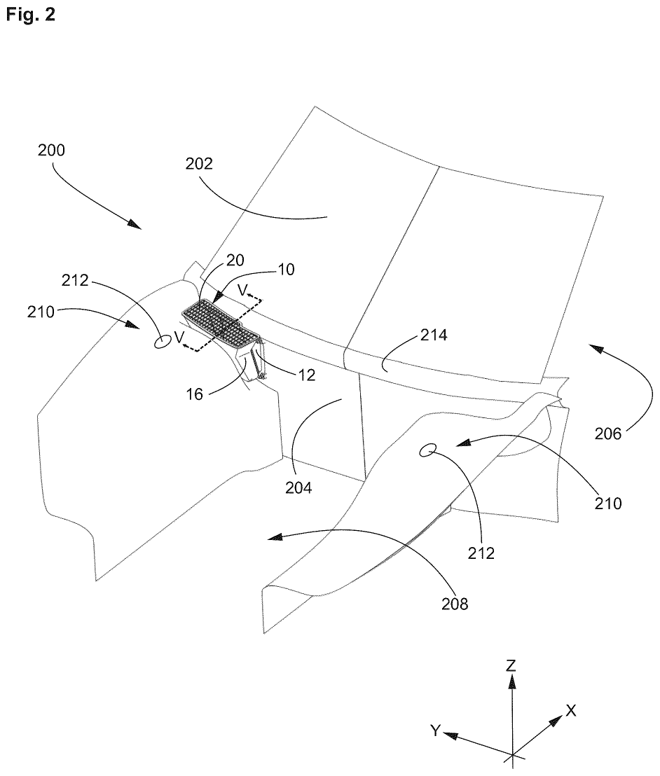

FIG. 2 shows a greatly simplified and schematic plan view of a front part of a motor vehicle 200. What can be seen in particular are a windshield 202 (windscreen) and an end wall 204 which separates a vehicle interior 206 from an engine compartment 208. Two spring strut towers 210 are indicated on the sides with schematically indicated fastening points 212 for spring struts not shown.

The windshield 202 is supported by a windshield cross member 214. The windshield cross member 214 is connected to the end wall 204.

In FIG. 2, it can be seen that the air intake module 10 is fastened to the end wall 204. More preferably, the base element 12 is screwed to the end wall 204 and the air guide element 16 is detachably connected to the base element 12. In addition, it is pointed out that the connection between the base element 12 and the end wall 204 may have a seal or sealing element to prevent fluid from entering between the base element 12 and the end wall 204.

The air intake module 10 is arranged in the longitudinal direction X of the motor vehicle 200 between the windshield cross member 214 and a respective spring strut tower 210. Stated another way, the air intake module 10 is provided laterally, more preferably on a passenger side of the motor vehicle 200.

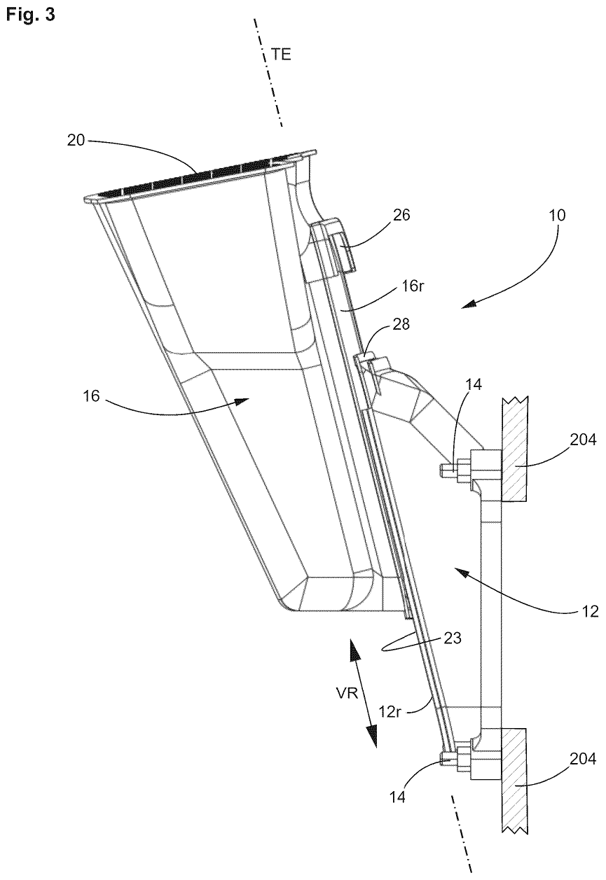

FIG. 3 shows the air intake module 10 in a side view, showing a state in which the air guide element 16 is not completely connected or attached to the base element 12.

In FIG. 3, it can be seen that the air guide element 16 and the base element 12 are movable relative to one another and guided relative to one another. More preferably, they may be displaced in a translational manner relative to one another, which is illustrated by the double arrow VR.

FIG. 3 indicates the end wall 204 in a simplified and sectional view, to which the base element 12 of the air intake module 10 is fastened, more preferably by means of screws 14.

Between the base element 12 and the air guide element 16, an imaginary separating plane TE is formed, which is indicated in FIG. 3 by a dash-dotted line. In this representation, the separating plane TE is orthogonal to the drawing plane.

In FIG. 1, it can also be seen that, on the base element 12, the base edge portion 12r is formed circumferentially along three sides, in particular at the bottom as well as on the left and right sides, of an air inlet opening 22. In particular, the base edge portion 12r forms a groove-like, circumferential receptacle 23. Stated another way, the base edge portion 12r is U-shaped along the air inlet opening 22.

The guide element edge portion 16r of the air guide element 16 is formed as a spring-like projection which is insertable into the groove-like base edge portion 16r or the receptacle 23 from above (direction of displacement VR in FIG. 3). The guide element edge portion 16r also delimits an air inlet opening 24 of the air guide element 16 (FIG. 1), which, in the assembled state, is arranged opposite the air inlet opening 22 of the base element (FIG. 3).

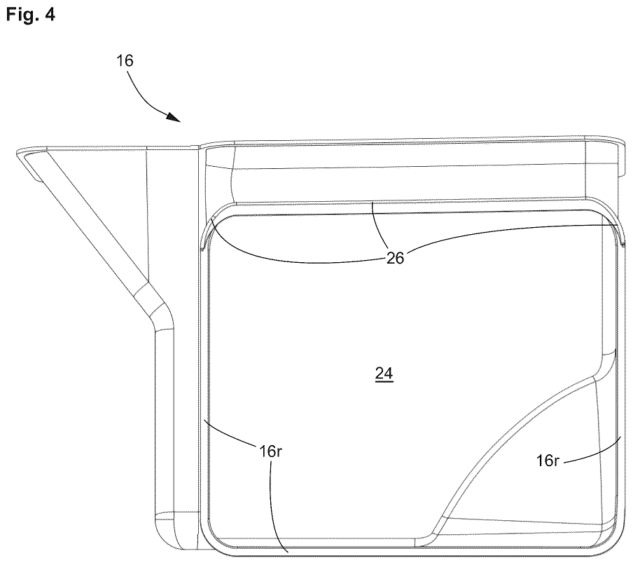

FIG. 4 shows a rear view of the air guide element 16. A groove-like receiving portion 26 is provided on the air guide element 16 along an upper edge of the air inlet opening 24. This receiving portion 26 serves to receive an upper edge 28 of the base element 12, which is free from the base edge portion 12r. This is also apparent from the illustration in FIG. 3.

When regarding FIGS. 1, 3 and 4 together, it can be seen that, in the assembled or connected state, the base edge portion 12r or the receptacle 23 of the base element 12 and the receiving portion 26 together form a circumferential boundary of the air inlet openings 22, 24.

Stated another way, the base edge portion 12r or the groove-like receptacle 23 of the base element 12 and the guide element edge portion 16r or the receiving portion 26 of the air guide element 16 are adapted or formed to correspond to one another, so that a, more preferably positive, connection is able to be established or is established between the base element 12 and the air guide element 16. As such, the air guide element 16 may be detached or separated at any time from the base element fastened to the body or the end wall 204 by an upwards sliding movement.

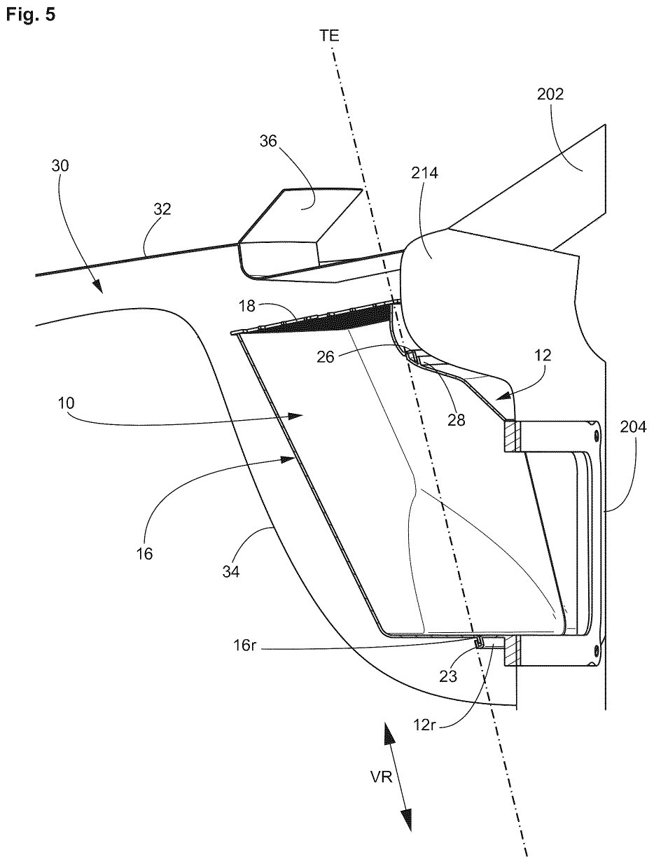

FIG. 5 shows a simplified and schematic sectional view approximately corresponding to the section line V-V of FIG. 2. In FIG. 5, the separating plane between the base element 12 and the air guide element 16 is indicated as a dash-dotted line TE.

In FIG. 5, the end wall 204, the windshield 202 and the windshield cross member 214 are also visible. As can be seen from the position of the separating plane TE, the base element 2 and the air guide element 16 are adapted such that the air guide element 16 may be or is attached to the base element 12 without undercuts in relation to the windshield cross member 214. Stated another way, the air guide element 16 of the air intake module 10 is arranged in front of the windshield cross member 214 or may be moved or displaced downwards in front of it (direction of displacement VR).

In other words, the air guide element 16 may be slid onto the base element 12 from above during assembly or installation, wherein the guide element edge portion 16r is guided past the windshield cross member 214. The same applies to a reverse movement when the air guide element 16 is removed upwards from the base element 12.

In FIG. 5, it can also be seen that the receptacle 23 is adapted to be groove-shaped and the guide element edge portion 16r is received in this receptacle 23 in a spring-like manner. Further, it can be seen that the receiving portion 26 of the air guide element 16 and the upper edge 28 of the base element 12 engage one another.

The air intake module 10 is arranged in a water tank 30 indicated in FIG. 5. The water tank 30 has a cover element 32 which is arranged above the air intake module 10. Further, the water tank 30 has a bottom element 34 which is arranged around the air intake module 10. A baffle 36 may be provided on the cover element 32 of the water tank 30 to divert a large part of the accumulating water to both sides of the vehicle.

1. An air intake module for an air conditioning unit of a motor vehicle, comprising:
a base element configured to be connected, more preferably screwed, to a body component of the motor vehicle, more preferably to an end wall separating the interior from an engine compartment and/or to a cross member of a windshield;
an air guide element having an air intake opening, which is configured to be fastened to the base element,
wherein the base element has a base edge portion facing the air guide element, and the air guide element has a guide element edge portion facing the base element, wherein the base edge portion and the guide edge portion are adapted such that the air guide element is detachably connectable or connected to the base element, more preferably by a positive and/or non-positive connection.

2. The air intake module according to claim 1, wherein the air guide element and the base element are movable relative to one another and guided relative to one another, more preferably displaceable in a translational manner.

3. A motor vehicle, having an internal combustion engine and/or electric drive, the motor vehicle having:
a body with an end wall separating a vehicle interior from an engine compartment, a windshield cross member arranged below a windshield and at least one spring strut tower arranged in front of the end wall;
an air intake module with a base element which is connected to the end wall and/or the windshield cross member, and with an air guide element having an air intake opening, which is fastenable or fastened to the base element,
wherein the base element has a base edge portion facing the air guide element, and the air guide element has a guide element edge portion facing the base element, wherein the base edge portion and the guide edge portion are adapted such that the air guide element is detachably connectable or connected to the base element, more preferably by a positive and/or non-positive connection.

4. The motor vehicle according to claim 3, wherein the base element is arranged below the windshield cross member and adapted such that the air guide element is arranged in front of the windshield cross member, more preferably mountable or mounted on the base element without an undercut to the windshield cross member.

5. The motor vehicle according to claim 3, wherein the air intake module is arranged between the end wall and the spring strut tower with respect to a longitudinal direction of the motor vehicle.

6. The motor vehicle according to claim 3, wherein the air guide element is movable relative to the base element connected to the end wall and/or the windshield cross member, more preferably displaceable along a height direction in a translational manner.

7. The motor vehicle according to claim 3, wherein it has a water tank with a base element and with a cover element, wherein the air intake module, more preferably the air guide element and its air intake opening, is arranged below the cover element.

8. The motor vehicle according to claim 7, wherein a water collection basin provided in the bottom element of the water tank is located lower than the air intake opening of the air intake module.

9. The motor vehicle according to claim 7, wherein an outer side of the air intake module, more preferably of the air guide element, faces the interior of the water tank.

10. The motor vehicle according to claim 4, wherein the air intake module is arranged between the end wall and the spring strut tower with respect to a longitudinal direction of the motor vehicle.

11. The motor vehicle according to claim 4, wherein the air guide element is movable relative to the base element connected to the end wall and/or the windshield cross member, more preferably displaceable along a height direction in a translational manner.

12. The motor vehicle according to claim 5, wherein the air guide element is movable relative to the base element connected to the end wall and/or the windshield cross member, more preferably displaceable along a height direction in a translational manner.

13. The motor vehicle according to claim 4, wherein it has a water tank with a base element and with a cover element, wherein the air intake module, more preferably the air guide element and its air intake opening, is arranged below the cover element.

14. The motor vehicle according to claim 5, wherein it has a water tank with a base element and with a cover element, wherein the air intake module, more preferably the air guide element and its air intake opening, is arranged below the cover element.

15. The motor vehicle according to claim 6, wherein it has a water tank with a base element and with a cover element, wherein the air intake module, more preferably the air guide element and its air intake opening, is arranged below the cover element.

16. The motor vehicle according to claim 8, wherein an outer side of the air intake module, more preferably of the air guide element, faces the interior of the water tank.
